(19) United States
(12) Patent Application Publication
(10) Pub. No.: US 2006/0088064 A1
(43) Pub. Date: Apr. 27, 2006

(54) Trejon interlink system

(76) Inventor: Trevis J. Dampier SR., San Jose, CA (US)

Correspondence Address: TRAVIS J. DAMPIER, 1002 SUMMERFIELD DR., SAN JOSE, CA, 95121, US

(21) Appl. No.: 10/971,647

(22) Filed: Oct. 25, 2004

(51) Int. Cl. H04J 3/06

(52) U.S. Cl. 370/503

(57) ABSTRACT

The Trejon Interlink System will allow you to watch the same movie on the big screen simultaneously right on your Rear-Seat Entertainment System or a video screen. This system will be built upon a wireless network that will include a database where the movies in digital format will be stored. Each screen will have a unique placement in the database (ex. like certain cells in a Excel spreadsheet match a certain topic), which will coincide with the customer, and the Trejon Interlink they were issued. The Trejon Interlink acts as an Access Point and will have RCA jacks connected to it, which will connect to the Rear Seat Entertainment System. There will be a broadcast from the server which will only connect to the designated MAC addresses in the Trejon Interlink that are placed within its sector in the database.

In these recent times Drive-In movie theaters have dropped revenue rapidly and many have shut down as walk-in movie theaters have taken a percentage of the business of drive-in theaters thanks to new technology in surround sound and a crisper view on the new big screens. Not to mention newly designed theaters that are much more comfortable to sit in for two hours or more. Why is this happening? I know for me, the reason I have stopped going to the Drive-in Theaters is because with 4 children its hard for all of us to see through one window and still be comfortable with every child on your lap or on your shoulder. Talk about complaining, we're talking back seat driver heaven! We used to have my kids sit on the roof in our sedan or take chairs with the mini-van and we would all sit in the front of the car but then you couldn't hear the sound that well from the radio and most of the time it got to cold outside, so we decided that summer time was the only good time to go to the Drive-In. I don't know if this problem is similar to anyone else, but hey maybe they just have a dirty windshield and can't see the screen that way. But overall I stopped going to the Drive-In all together because of the above complaints but I still have the motivation in me that still would like to go.

With technology increasing and businesses utilizing new innovations times like these can stop. The Trejon Interlink System is the rebirth of the 1950's Drive In Theater and we will now introduce the Millennium Drive-In Theater. The Trejon Interlink System will allow you to watch the same movie on the big screen simultaneously and at the same clocking speed/time on your Rear-Seat Entertainment System or a video screen. No more having to watch a big screen movie outside in the cold, no more back seat drivers screaming in irritation, and finally a romantic night at the drive-in where you never have to leave the back seat. By the way, no more having to stand in line at the walk-in theater in a thunderstorm when you can have surround sound in your car, suv, mini-van, with the privacy you need to talk or scream or just take your shoes off and relax.

How does it work? This system will be built upon a wireless network that will include a database where the movies in digital format will be stored. Each screen will have a unique placement in the database (ex. like certain cells in a Excel spreadsheet match a certain topic), which will coincide with the customer, and the Trejon Interlink they were issued. The Trejon Interlink acts as digital data receiver and will have RCA jacks connected to it, which will connect to the Rear Seat Entertainment System. There will be a broadcast from the server which will only connect to the designated MAC addresses in the Trejon Interlink that are placed within its sector in the database.

| Spiderman 2 | Passion Of The Christ | Catwoman |
|---|---|---|
| 00-4356-8769 | 00-4356-8762 | 00-5678-9802 |
| 00-4356-8770 | 00-4356-8763 | 00-5678-9803 |
| 00-4356-8771 | 00-4356-8764 | 00-5678-9804 |
| 00-4356-8772 | 00-4356-8765 | 00-5678-9805 |
| 00-4356-8773 | 00-4356-8766 | 00-5678-9806 |
| 00-4356-8774 | 00-4356-8767 | 00-5678-9807 |
| 00-4356-8775 | 00-4356-8768 | 00-5678-9808 |
| 00-4356-8776 | 00-4356-8769 | 00-5678-9809 |
| 00-4356-8777 | 00-4356-8770 | 00-5678-9810 |
| 00-4356-8778 | 00-4356-8771 | 00-5678-9811 |

As far as the wireless networking technology, that technology is already available, but the Trejon Interlink and the database software to communicate with the device will need to be developed. Since there are devices like the PDA's and cell phones with wireless technology the development should not be costly. As far as staff goes, this is still under consideration, if we make a deal with a wireless network company that has staff in each state and city where the TJI System is in place, we will have a warranty on the network and support if anything goes down without us having to find our own technical staff. Contract deals with owners/companies of the Drive-In Theaters are going to be the key in this, but it's going to take more than a few good pitches. We will first need to implement the TJI System into an active Drive-In Theater, and gain successful results. We will do so by advertising on the local radio station, local newspapers and Internet. The Drive-In Theater would have to help promote, by letting people utilize the TJI System for free at first for a week or a low charge rate. Once the word is out in that city and customers are using the system progressively more we would take the results of revenue and success rates that were made in the first 60 days and use those results to market the system from there. The key is not to sell the Trejon-Interlink's to consumers but to lease them to the Drive-In Theaters. This will prevent hackers and have continuous revenue coming in.

### BRIEF DESCRIPTION OF DRAWINGS

FIG. 1 is a view of the combination of a server containing database software, a digital movie projector, an access point, digital data receiver (Trejon Interlink) and rear seat dvd/vcr system.

FIG. 2 is a view of a digital data receiver (Trejon Interlink) with RCA plugs and a rear seat dvd/vcr system.

FIG. 3 is a view of a server containing database software, digital movie projector and an access point.

FIG. 4 is a view of an access point and a digital data receiver (Trejon Interlink) and a rear seat dvd/vcr system.

### DETAILED DESCRIPTION

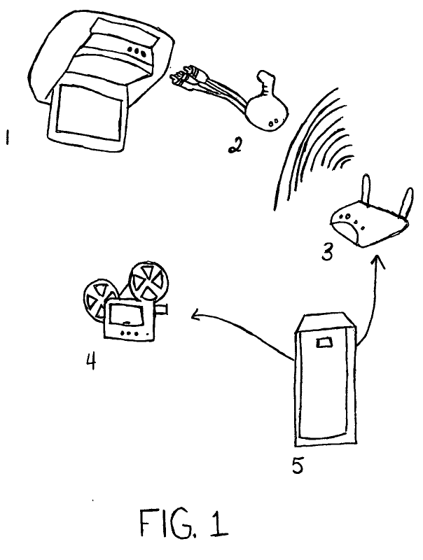

Referring to the embodiment of the invention shown in FIGS. 1, 2, 3, and 4, there is shown a wireless networking system, a combination of a server containing database software that contains where movies in digital format will be stored in the server, digital data receiver MAC/IP addresses, digital projector MAC/IP addresses, broadcast information for digital movie data to be broadcast to specific digital data receivers (Trejon Interlink), an access point that outputs digital data to digital data receivers (Trejon Interlink), a digital data receiver (Trejon Interlink) outputting data through RCA plugs to RCA jacks connected to a rear seat dvd/vcr system or output device.

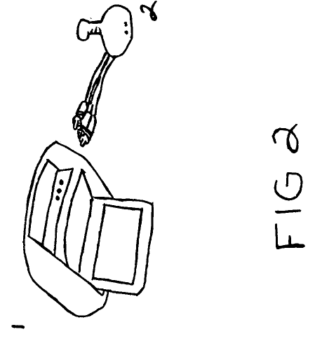

FIG. 2 shows a digital data receiver (Trejon Interlink) of claim 6 connecting and distributing data by way of RCA plugs to RCA jacks that are connected to rear seat dvd/vcr system or video or video output device. The digital data receiver (Trejon Interlink) is outputting digital movie data that will play movie simultaneously and at the same clocking speed/time as the digital movie projector.

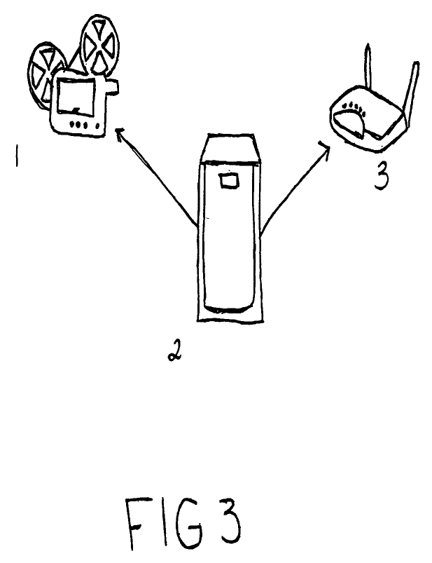

FIG. 3 shows a server that contains database software broadcasting to digital movie projector and access point.

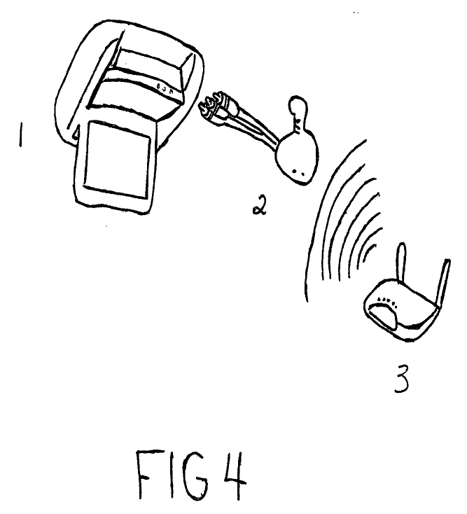

FIG. 4 shows network connection to access point and digital data receiver (Trejon Interlink). Movie projector will play movie simultaneously and at the same clocking speed/time as the digital data receiver.

What is claimed is:

1. In a wireless networking system, the combination of a database software comprising of digital data to output to a digital movie projector and digital data to output to an access point simultaneously, and a access point that outputs digital data to digital data receiver (Trejon Interlink), digital data receiver outputs data through RCA plugs to RCA jacks connected to rear seat dvd/vcr system or video output device that will play movie at the same clocking speed/time as the digital projector and simultaneously.

2. The combination defined in claim 1, wherein the database software outputs digital data simultaneously using wireless networking technology to output data to digital movie projectors and digital data to access points, access points to output data to specific Mac/IP address or domain name of digital data receiver, whereby data is outputted by software database on wireless network server to each digital movie projector and/or digital data receiver.

3. A database software of claim 2, wherein said software allows digital data to be distributed to specific digital movie projectors and digital data receivers simultaneously using, servers, wireless networking and access points.

4. A database software of claim 2, wherein said software broadcasts digital data to access points that output digital data by broadcasting radio frequency signal to digital data receivers.

5. A database software of claim 2, wherein said software will contain where the movies in digital format will be stored in the server, digital data receivers Mac/lP addresses, digital projector Mac/IP addresses, broadcast information for digital movie data to be broadcast to specific digital data receivers.

6. An access point of claim 1, wherein said access points output digital data to digital data receivers by Mac address or domain name on wireless network.

7. A digital data receiver of claim 1, wherein said digital data receiver is connected to rear seat dvd/vcr system or video output device with RCA plugs.

8. A digital data receiver of claim 1, wherein said digital data receiver is encrypted with specific Mac address or assigned a domain name on wireless network.

9. A digital data receiver of claim 1, wherein said digital data receiver receives digital data from access point on wireless network and outputs received digital data to rear-seat dvd/vcr system or video output device.

10. A digital data receiver of claim 1, wherein said digital receiver is composed of RCA jack plugs, RJ45 connector to connect to computer network, on and off switch, wireless networking card and ability to output data to each specific RCA plug for sound and color and video.
